(19) United States
(12) Patent Application Publication
(10) Pub. No.: US 2019/0335732 A1
(43) Pub. Date: Nov. 7, 2019

(54) FISHING NET

(71) Applicant: Plano Molding Company, Plano, IL (US)

(72) Inventors: Meegan Daigler, Brooklyn, NY (US); Kaitlyn Benoit, New York, NY (US); Neil Kwiatkowski, Queens, NY (US); Charles Paradise, Brooklyn, NY (US)

(21) Appl. No.: 16/400,765

(22) Filed: May 1, 2019

Related U.S. Application Data
(60) Provisional application No. 62/665,915, filed on May 2, 2018.

(51) Int. Cl. A01K 77/00; A44B 19/32; A01K 75/00

(52) U.S. Cl. CPC A01K 77/00; A01K 75/00; A44B 19/32

(57) ABSTRACT

A fishing device that comprises a basket and a handle or pole. The basket includes a hoop and a net attached to the hoop, wherein the net has a mesh design that minimizes fluid resistance or drag. The fishing device can include a first contact panel that guides fish into the bottom of the net. The fishing device can include a second contact panel that guides fish into the bottom of the net, wherein the second contact panel is positioned substantially opposite to the first contact panel.

### CROSS REFERENCE TO PRIOR APPLICATION

This application claims priority to and the benefit thereof from U.S. Provisional Patent Application No. 62/665,915, filed May 2, 2018, titled “Fishing Net,” the entirety of which is hereby incorporated herein by reference.

### FIELD OF THE DISCLOSURE

The disclosure relates generally to a fishing net device and, more particularly, a fishing net device having a net, a hoop and a handle or pole.

### BACKGROUND OF THE DISCLOSURE

A variety of fishing nets are known. These typically include a net attached to a hoop, which in turn is attached to a pole or handle. The devices come in many shapes and sizes. FIG. 1 shows an example of a known fishing net device. Known fishing net devices suffer from a number of disadvantages, including, for example, substantial fluid resistance when moving through water, susceptibility to snagging or tangling, or designs that prevent fish from efficiently or effectively sliding into the net.

An unfulfilled need exists for a fishing net device that overcomes the above-noted disadvantages.

### SUMMARY OF THE DISCLOSURE

According to the principles of the disclosure, a fishing device is disclosed that comprises a net having a mesh design that minimizes fluid resistance or drag. The fishing device can include a first contact panel that can guide a fish into the bottom of the net. The fishing device can include a second contact panel that can guide the fish into the bottom of the net, wherein the second contact panel can be positioned substantially opposite to the first contact panel.

The first contact panel can include a hook-proof material. The second contact panel can include the same material as the first contact panel.

The first contact panel can be positioned at a first end of the basket. The first end of the basket can be the front end of the fishing device.

The second contact panel can be positioned at a second end of the net. The second end of the net can be the back end of the net.

According an embodiment of the disclosure, a fishing device is provided that comprises a basket that can receive and hold an object such as a fish and a handle or a pole that can be attached to the basket. The basket can comprise a hoop and a net. The net can include a pattern that minimizes fluid resistance. The net can be attached to the hoop.

The fishing device can include a net fastener. The hoop can include a channel that runs along a portion or the entirety of the hoop. The net fastener can include a first portion that can be located in the channel in the hoop. The net fastener can include a second portion that attaches to the net. The first portion can include a plurality of waterproof zipper teeth. The waterproof zipper teeth can be attached to or formed as part of a top portion of the net. The first portion can be adapted to be fed into the channel in the hoop to fasten the net to the hoop.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a known fishing net.

FIG. 2 shows a first view of an embodiment of a fishing device that is constructed according to the principles of the disclosure.

FIG. 3 shows a second view of the embodiment of the fishing device in FIG. 2.

FIG. 4 shows a third view of the embodiment of the fishing device in FIG. 2.

FIG. 5 shows a fourth view of the embodiment of the fishing device in FIG. 2.

FIG. 6 shows a fifth view of the embodiment of the fishing device in FIG. 2.

FIG. 7 shows an embodiment of a net that is constructed according to the principles of the disclosure.

FIG. 8 shows a sixth view of the embodiment of the fishing device in FIG. 2.

FIG. 9 shows a cross-section view of an example of a net fastener, according to the principles of the disclosure.

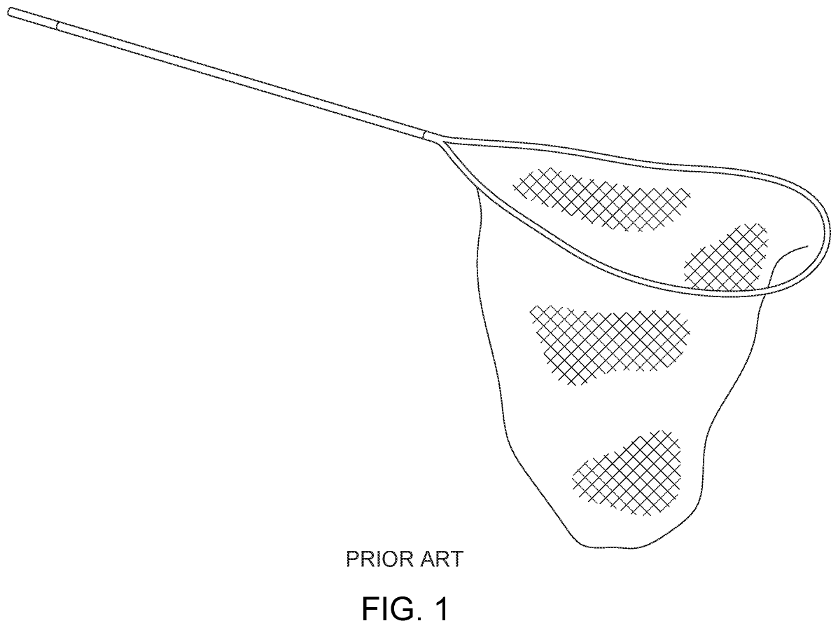

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. It should be noted that the features illustrated in the drawings are not necessarily drawn to scale, and features of one embodiment can be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure can be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

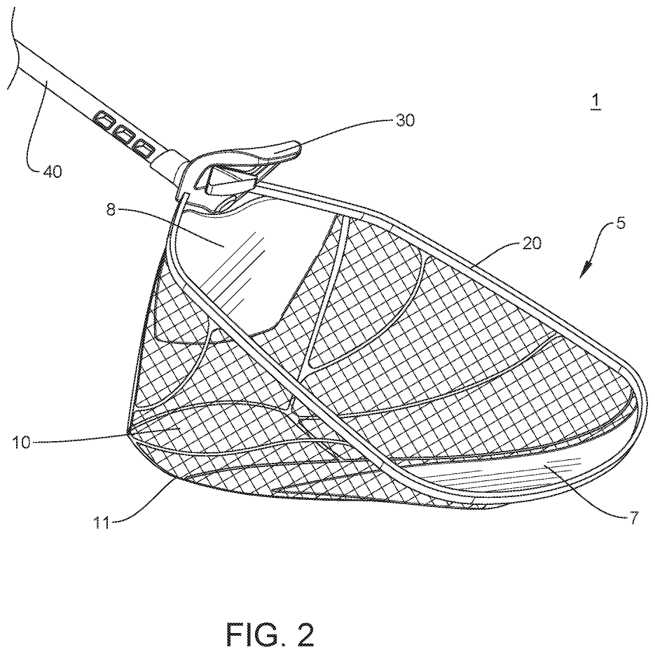

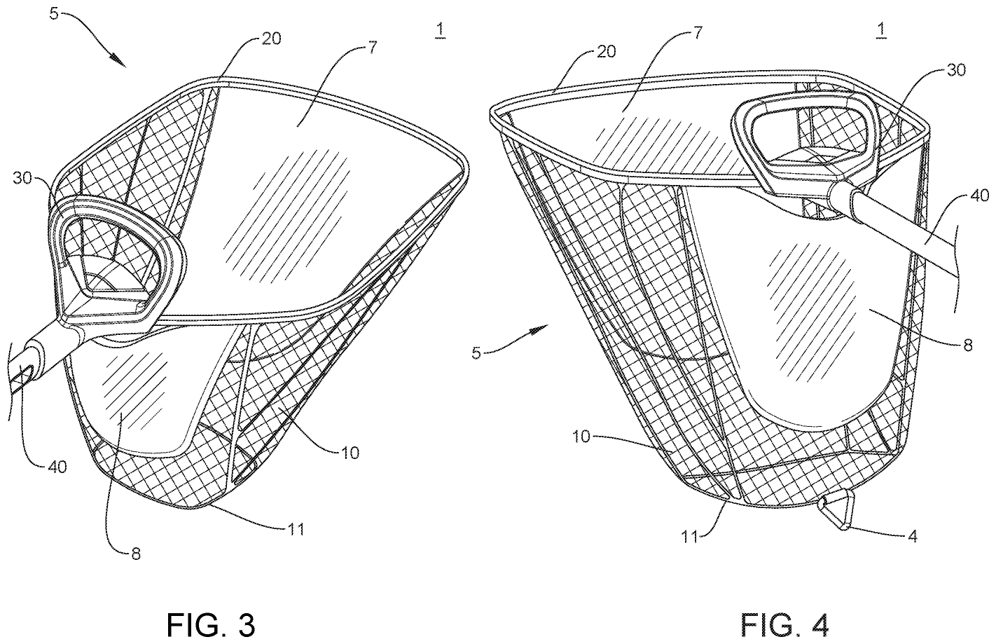

FIGS. 2-6 and 8 show various views of an embodiment of a fishing device 1, constructed according to the principles of the disclosure. Referring to FIGS. 2-6 and 8, the fishing device 1 comprises a net 10. The fishing device 1 can comprise a basket 5. The basket 5 can include the net 10. The fishing device 1 can comprise a handle 30 or a pole 40, or both the handle 30 and the pole 40. The basket 5 can include a hoop 20. The hoop 20 can be connected to or integrally formed with the net 10. The hoop 20 can be connected to or integrally formed with the handle 30 or pole 40. The fishing device 1 can be collapsible (or expandable) to minimize necessary storage or transport space, or fixed.

The fishing device 1 is constructed to optimally balance minimizing drag force during proper implementation while simultaneously providing for optimal guiding of objects into the net 10, where drag force depends on the speed at which the water flows into the net 10 and the cross-sectional area of the net 10 contacted by the flowing water.

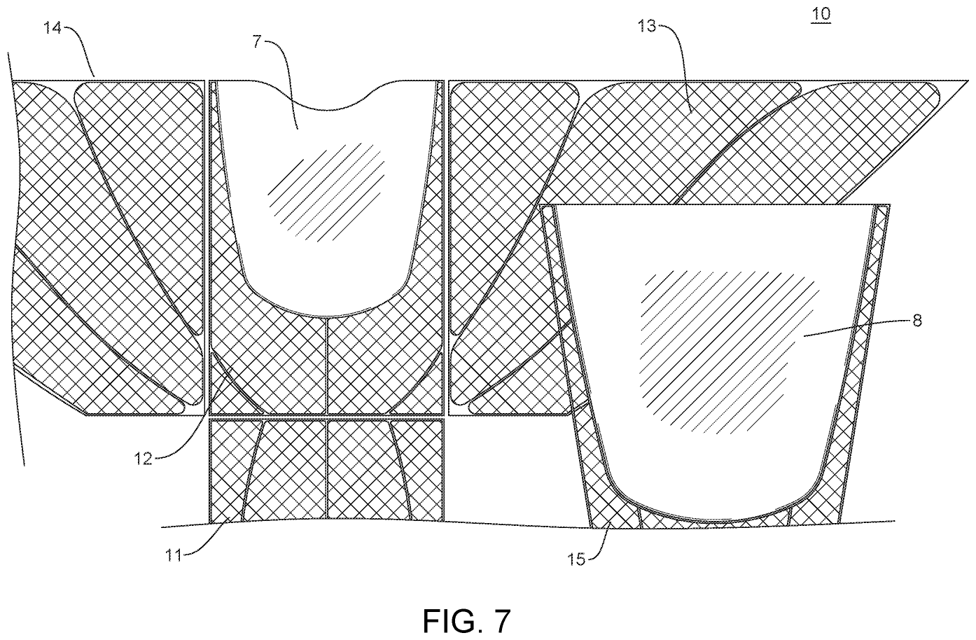

FIG. 7 shows an embodiment of the net 10, constructed according to the principles of the disclosure. The net 10 can comprise a plurality of panels 11-15 that can be assembled to form the net 10. The panels 11-15 can be fastened to each other by, for example, an adhesive, stitching, fusion, fasteners, tongue-and-groove, or a hinge. The net 10 can be formed as a single piece (not shown) or multiple pieces, as seen in FIG. 7. In the multi-piece embodiment (for example, shown in FIG. 7), the panels 11-15 can be attached to each other to form the net 10. The panels 11-15 can include a bottom panel 11, a front panel 12, a back panel 15, and side panels 13, 14.

In the single piece embodiment (not shown), each of the panels 11-15 can be formed as a portion of a single piece structure. The single piece structure can be formed by molding, injection molding, die casting or other manufacturing process or technology that can create the single piece structure made of a material such as, for example, plastic, metal, carbon fiber, fiberglass, nylon, or other material suitable for freshwater or saltwater applications. The single piece structure can be formed with the panels 11-15 and living hinges between the panels, as appropriate, to allow adjoining ones of the panels 11-15 to bend or pivot with respect to each other to form a single piece structure net 10. The single piece embodiment can be formed to have a single structure having the mesh patterns shown in FIGS. 2-6 and 8, thereby eliminating any need to attach portions of panels 11-15 to each other to form the structure.

Referring to FIG. 7, the net 10 can include one or more contact panels 7, 8. The net 10 can include a contact panel 7 affixed to or integrally formed with the front panel 12. The net 10 can include a contact panel 8 affixed to or integrally formed with the rear panel 15. The net 10 can include a contact panel (not shown) affixed to or integrally formed with the bottom panel 11. The net 10 can include a contact panel (not shown) affixed to or integrally formed with one or both side panels 13, 14.

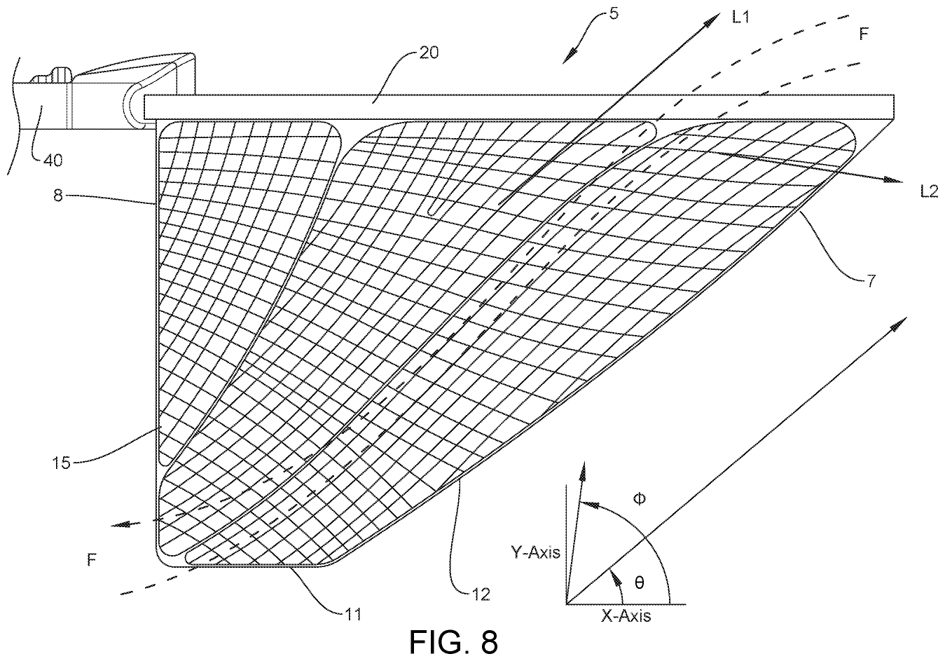

The panel 11 can include a mesh having a pattern (for example, shown in FIG. 7) that provides optimal fluid flow-through for a fluid F (shown in FIG. 8) such as freshwater or saltwater flowing at an angle θ with respect to the plane of the bottom panel 11, which is parallel with the X-axis shown in FIG. 8. The angle θ can be between 0° and 90° with respect to the X-axis, and preferably between 15° and 75°, and more preferably between 30° and 60° with respect to the X-axis. It is noted that the angle θ can be greater than 90°.

The panel 11 can include a contact panel (not shown) similar to the contact panels 7 or 8. The contact panel(s) 7 or 8 can, however, increase drag forces on the fishing device 1 during implementation. To reduce the drag forces, the contact panels 7 or 8 (or contact panel (not shown) included in panel 11) can include openings to permit flow-through of fluid.

In a non-limiting embodiment of the fishing device 1, the plane of the hoop 20 in the basket 5 is substantially parallel with the X-axis, as seen in FIG. 8.

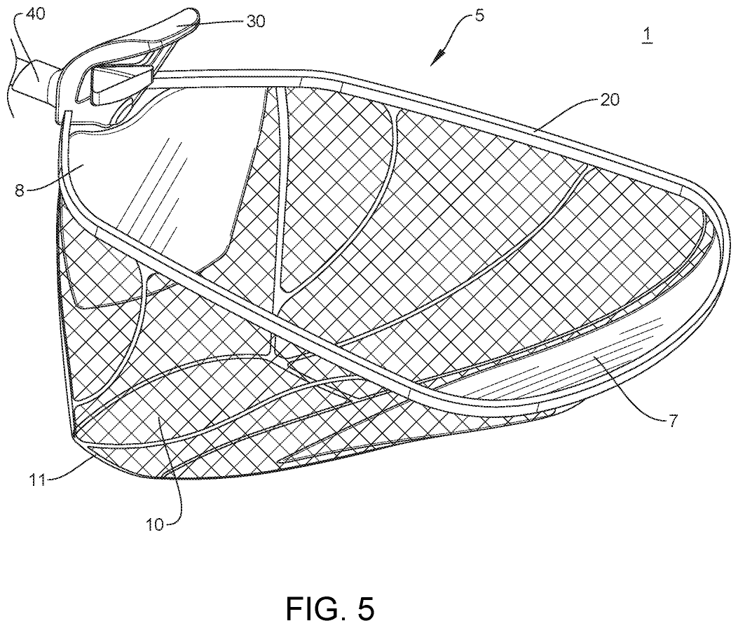

The panels 13 and 14 can include a mesh having a wave pattern, such as, for example, shown in FIGS. 5-8, that provides optimal fluid flow-through and minimal fluid resistance for the fluid F flowing at an angle θ with respect to the X-axis (shown in FIG. 8), where the angle θ is between 0° and 90° with respect to the X-axis, and preferably between 15° and 75°, and more preferably between 30° and 60° with respect to the X-axis. It is noted that angles greater than 90° are contemplated herein.

The mesh pattern(s) can comprise first lines L1 and second lines L2. The lines L1 and L2 can form the panels 11, 12, 13, 14, or 15. A portion or the entirety of the lines L1 in panels 13 and 14 can be formed to have the angle θ with respect to the plane of the hoop 20 (shown in FIG. 8). According to a non-limiting embodiment of the net 10, the lines L1 in panels 13 and 14 can be formed to have a varying angle that gradually increases (or decreases) from angle θ to, for example, an angle φ with respect to the X-axis, where φ can be between 60° and 90°, and more preferably between 75° and 90° with respect to the X-axis.

Referring to FIGS. 2-6 and 8, the basket 5 includes the net 10 and the hoop 20. The basket 5 can include a net hold 4 (shown in FIG. 4). The basket 5 can be coupled to the handle 30 or pole 40. The net 10 can be attached to the hoop 20 by means of, for example, an adhesive, stitching, fusion, fasteners, tongue-and-groove, or any other mechanism suitable to securely attach the net 10 to the hoop 20.

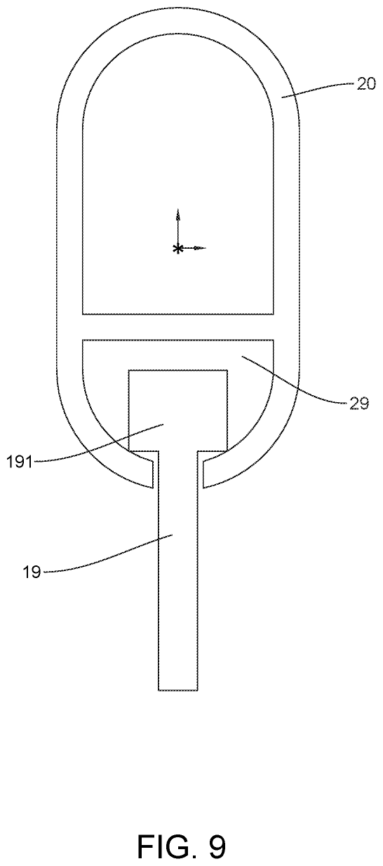

FIG. 9 shows an example of a net fastener constructed according to the principles of the disclosure. The net fastener can include a first portion 191 and a second portion 19. The first portion 191 and second portion 19 can be formed as a single device or formed as separate devices and attached to each other. The net fastener can include a waterproof zipper that can be attached to the net 10 and to the hoop 20. In the case of a water zipper, the first portion 191 can include the teeth of the zipper and the second portion 19 can include the zipper body. The first portion 191 and second portion 19 can include, for example, a rubber extrusion that is formed with a larger width or thickness for the first portion 191 than the width or thickness of the second portion 19. The second portion 19 can be fastened or attached (for example, sewn) to the top of the net 10, or integrally formed as part of the top of the net 10. The first portion 191 (for example, teeth of the zipper) can be fed into a channel 29 in the hoop 20. The channel 29 can be formed along the entire length or less than the entire length of the hoop 20. The hoop 20 can include a cutout (not shown) that is sufficiently wide enough to allow the first portion 191 of the net fastener to pass there-through and enter the channel 29. The cutout (not shown) can be formed in a portion of the hoop 20 that is affixed to the handle 30 or pole 40, such that when the fishing device 1 is assembled, the cutout is not visible or accessible, thereby preventing the first portion 191 from exiting the channel 29.

Alternatively, the net attachment mechanism can include a cord (not shown) which can be fed into the channel 29 in the hoop 20. The net 10 can include a sleeve (not shown) that can receive and hold the cord (not shown). The sleeve with cord can be fed into the channel 29 in the hoop 20.

The net 10 can be integrally formed with the hoop 20 as a single piece.

The basket 5 can include one or more contact panels 7, 8, which can be provided as part of the net 10 or affixed to the net 10 in the basket 5. The basket 5 can include the contact panel 7 located at a first (or front) end of the basket 5. The basket 5 can include the contact panel 8 located at a second (or back) end of the basket 5. As seen in FIG. 2, the contact panel 8 can be located substantially opposite the contact panel 7.

As seen in FIGS. 2-6, the contact panel 7 can be located at the front end of the basket 5, which can be formed at the angle θ, to guide objects such as fish as they slide into the bottom of the basket 5. The contact panel 8 can be located at the back end of the basket 5 to ensure the objects slide to the bottom of the basket 5 and do not get caught in the net 10. The contact panel 8 can be formed at an angle φ (shown in FIG. 8) with respect to the X-axis, where φ is between 75° and 135°, and preferably between 90° and 120°, and more preferably between 90° and 105° with respect to the X-axis. The bottom of the basket 5 can include the panel 11, which can be formed as a planar panel that is substantially parallel with the plane of the hoop 20 and X-axis (shown in FIG. 8).

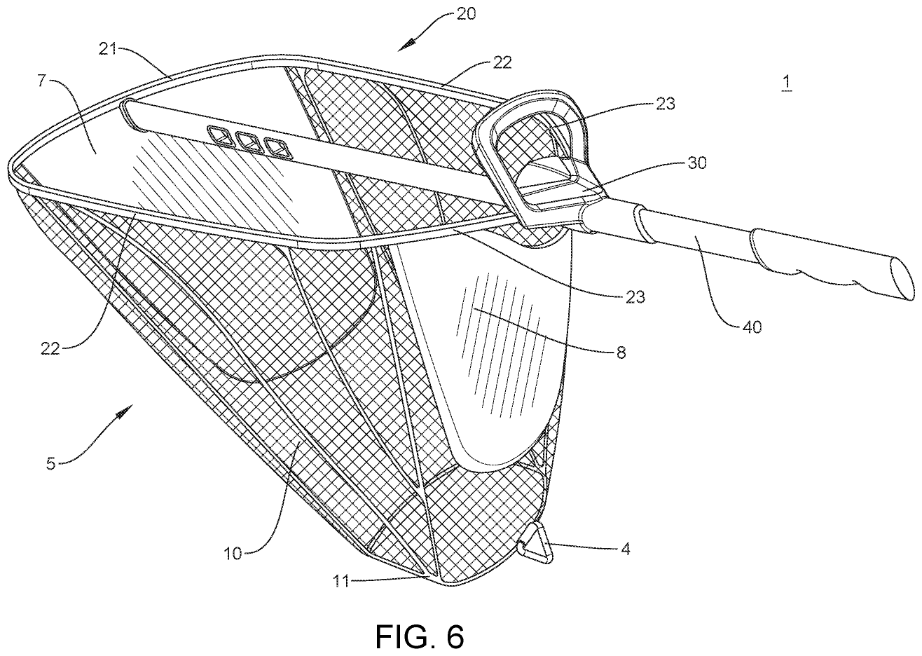

Referring to FIG. 6, the hoop 20 can have a semi-flat front portion 21 that can facilitate creating a substantially flat front panel 12 of the basket 5. The hoop 20 can include a channel (for example, channel 29 shown in FIG. 9) that runs along its entire (or a portion thereof) of its length, wherein the channel is configured to receive the first portion 191 of the net fastener, as discussed above with reference to FIG. 9. The hoop 20 can have a pair of substantially parallel longitudinal portions 22 and a pair of tapered portions 23 that taper from the longitudinal portions 22 toward the handle 30 or pole 40. The net 10 can be attached to the hoop 20 as discussed above.

Referring to FIG. 6, the fishing device 1 can be implemented by a user by holding on to the handle 30 or pole 40 with one hand and gripping the net hold 4 (shown in FIG. 4) with the other hand, thereby allowing the user to hold back the net 10 while, for example, netting a fish that is trolling, so the net 10 does not wash forward when netting the fish. When netting the fish, the user can move the fishing device 1 in the water toward the fish, positioning the fishing device 1 so that water flows into the basket 5 in the direction F (shown in FIG. 8). As the fish goes into the basket 5, the contact panel 7 can guide and allow the fish to slide into the bottom of the net 10 with very little resistance. Meanwhile, the contact panel 8 can ensure the fish slides to the bottom of the net 10 instead of getting caught in the back of the net 10 or at the top of the basket 5. The shape of the net 10 guides the fish to the bottom of the net 10 when netting the fish, such as, for example, when moving the net 10 toward the fish to capture the fish. The substantially flat panel on the bottom of the net 10 can hold or allow the fish to lay, for example, semi-flat in the bottom of the net 10.

The net hold 4 (shown in FIG. 40 can be used to bring the net 10 close to the handle 30 or pole 40 when collapsing the fishing device 1 for storage or transport.

The net hold 4 can be used to hang the fishing device 1 on a wall, on a display rack, or any other structure.

The fishing device 1, including each of its components, can be made of any material suitable for the intended purpose. For instance, the net 10 can be made from plastic, metal, twine, braided fishing line, or any other material suitable to receive and hold an object such as a fish. The contact panels 7, 8, hoop 20, handle 30, or pole 40 can be made from, for example, plastic, metal, wood, carbon fiber, fiberglass, or any other material suitable for the intended purposes.

The terms “including,” “comprising,” and variations thereof, as used in this disclosure, mean “including, but not limited to,” unless expressly specified otherwise.

The terms “a,” “an,” and “the,” as used in this disclosure, means “one or more,” unless expressly specified otherwise.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. A fishing device, comprising:
a basket that receives and holds an object; and
a handle attached to the basket,
wherein the basket comprises:
a hoop; and
a net attached to the hoop, the net including a pattern that minimizes fluid resistance.

2. The fishing device of claim 1, further comprising a pole.

3. The fishing device of claim 1, further comprising:
a plurality of waterproof zipper teeth attached to or formed as part of a top portion of the net,
wherein the plurality of waterproof zipper teeth are adapted to be fed into a channel in the hoop to fasten the net to the hoop.

4. The fishing device of claim 1, wherein the net comprises at least one panel having the wave pattern.

5. The fishing device of claim 4, wherein the at least one panel having the wave pattern comprises a pair of side panels of the net.

6. The fishing device of claim 4, wherein the net includes five panels that are assembled as a single piece, the five panels being attachable to form a structure to hold a fish.

7. A fishing device, comprising:
a basket that receives and holds an object; and
a pole attached to the basket,
wherein the basket comprises:
a hoop; and
a net attached to the hoop, the net including a pattern that minimizes fluid resistance.

8. A fishing device, comprising:
a net having a plurality of panels,
wherein the plurality of panels includes at least one panel having a wave pattern that minimizes fluid resistance.

9. The fishing device of claim 8, wherein the at least one panel having the wave pattern comprises a side panel of the net.

10. The fishing device of claim 8, wherein the at least one panel having the wave pattern comprises a pair of side panels of the net.

11. The fishing device of claim 8, wherein the plurality of panels includes five panels that are assembled as a single piece, the five panels being attachable to form a basket-net structure to hold a fish.

12. The fishing device of claim 8, further comprising:
a basket that includes the net,
wherein the net has the wave pattern that minimizes fluid resistance.

13. The fishing device of claim 8, further comprising:
a first contact panel that guides an object into the bottom of the net.

14. The fishing device of claim 13, further comprising:
a second contact panel that guides the object into the bottom of the net,
wherein the second contact panel is positioned substantially opposite to the first contact panel.

15. The fishing device of claim 13, wherein the first contact panel comprises a hook-proof material.

16. The fishing device of claim 14, wherein at least one of the first contact panel and the second contact panel comprises a hook-proof material.

17. The fishing device of claim 13, wherein the first contact panel is located at a first end of the net.

18. The fishing device of claim 13, wherein
the first contact panel is located at a first end of the net, and
the second contact panel is located at a second end of the net, the second end of the net being substantially opposite to the first end of the net.

19. The fishing device of claim 12, wherein the basket includes a hoop that is attached to the net.

20. The fishing device of claim 19, wherein the hoop comprises a channel that receives and holds a net fastener that is attached to or formed as part of a top portion of the net to fasten the net to the hoop.
